(19) United States
(12) Patent Application Publication
(10) Pub. No.: US 2022/0297085 A1
(43) Pub. Date: Sep. 22, 2022

(54) CROSSLINKED BINDER COMPOSITION

(71) Applicant: Arkema Inc., King of Prussia, PA (US)

(72) Inventors: Florence MEHLMANN, King of Prussia, PA (US); Azaz A. VAHORA, King of Prussia, PA (US)

(21) Appl. No.: 17/616,780

(22) PCT Filed: Jun. 23, 2020
(86) PCT No.: PCT/US2020/039107

§ 371 Date: Dec. 6, 2021

Related U.S. Application Data
(60) Provisional application No. 62/866,202, filed on Jun. 25, 2019.

(51) Int. Cl. B01J 20/26; B01J 20/20; B01J 20/28; C02F 1/28; B01D 15/00; B01D 53/04

(52) U.S. Cl. CPC B01J 20/267; B01J 20/20; B01J 20/2803; B01J 20/28007; C02F 1/283; B01D 15/00; B01D 53/04; B01D 2253/102

(57) ABSTRACT

The invention relates to a solid porous article having a crosslinked thermoplastic binder interconnecting one or more types of interactive powdery materials or fibers. The interconnectivity is such that the binder connects the powdery materials or fibers in discrete spots rather than as a complete coating, allowing the materials or fibers to be in direct contact with, and interact with a fluid. The resulting article is a formed multicomponent, interconnected web, with porosity. The separation article is useful in water purification, as well as in the separation of dissolved or suspended materials in both aqueous and non-aqueous systems in industrial uses, gas storage.

### FIELD OF THE INVENTION

The invention relates to a crosslinked thermoplastic polymer binder, and the use of the binder to form porous articles, block structures or monoliths with active media made of interactive particles or fibers. The porous articles can be used for the filtration, separation, or storage of fluids, or for parts of energy devices such as electrodes of batteries and capacitors.

### BACKGROUND OF THE INVENTION

It is known that porous active media, such as activated carbon, benefit from being combined with a binder and turned into monoliths or blocks by processes such as compression molding or extrusion. The role of the binder is to connect the particles of active media, so it holds the structure together, making it easier to handle, and possibly densifying the active media. In order to maximize the performance of the monolith, it is critical that the binder does not foul (or coat) the surface of the active media, as this results into a loss of available specific surface area and pore volume, which negatively affects the performance of the media for the filtration, separation, or storage of fluid components, or for parts of energy devices such as electrodes of batteries and capacitors.

Thermoplastic polymers are known as binders for active media. They can be made as particulate materials of a wide range of particle sizes. They undergo sufficient deformation (polymer flow) during processes such as compression molding, extrusion, or calendaring processes above their softening point, which can be described as the glass transition temperature for amorphous polymers, and as the melting point for crystalline and semi-crystalline polymers, to efficiently anchor into particles of the active media. However, such polymer flow also leads to fouling of the surface and pores of the active media and to a decrease in the performance of the active media for the intended uses.

U.S. Pat. No. 4,999,330 describes the needs and challenges for the high-density adsorbent monoliths used in gas storage systems. The efficiency of the system depends on the level of surface area and pore volume of the adsorbent, the density of the packing of the adsorbent, the physical stability of the 3-D structure, and the level of fouling of the adsorbent. U.S. Pat. No. 4,999,330 uses an aqueous methyl cellulose or polyvinyl alcohol binder as a solution, to coat high surface area carbon particles, followed by removing the solvent and compressing the binder-coated particles to cause a bulk volume reduction of 50 to 200%. The '330 system suffers from its complexity and many steps. It also involves coating the entire activated carbon particles—which blocks many of the adsorbent pores—this fouling reducing the amount of surface area available for adsorption. U.S. Pat. No. 6,696,384 also describes the use of methyl cellulose as an aqueous binder that coats the surface of active media. It points out the low mechanical strength of the resulting monolith, which it attempts to resolve by crosslinking the cellulosic binder after the monolith is formed. The crosslinking process has no positive effect on the significant fouling of the active media, as it occurs at the same time or after the process of coating the media to form the monolith.

Other prior art describe the use of non aqueous thermoplastic polymer binders as a solid or a solid dispersion in water, which leads to less fouling of the active media, because the binder does not coat the whole surface of the active media, but rather connects to the particles of active media in discrete spots.

U.S. Pat. Nos. 5,019,311, 5,147,722 and 5,331,037 describe an extrusion process to produce a porous structure containing interactive particles bound together by a thermoplastic polymer binder. The porous structure is described as a “continuous web matrix”, or “forced point bonds”. The solid composite article is useful as a high performance water filter, such as in a carbon block filter. U.S. Pat. No. 6,395,190 describes carbon filters and a method for making them having 15 to 25 weight percent of a polyolefin thermoplastic binder. (IR4203)US 2016/121249 states that select thermoplastic polymers such as PVDF and polyamides are unusually polarized, and have a reduced tendency to wet carbon surfaces and cause fouling of the adsorbent's surfaces than other thermoplastics described in the art. (IR4263) US2018/104670 describes the use of PVDF binder with high molecular weight, having a melt viscosity greater than 1.0 Kpoise according to ASTM D-3835 at 450F and 100 sec⁻¹, to minimize the fouling of active particles.

However, it is known that all thermoplastic polymer binders still foul the surface of the active media to some extent, even those with high polarity, or high molecular, high viscosity. This is because they undergo some deformation (polymer flow) under the temperature and pressure conditions needed to make the monolith, typically at least 20 C, or at least 40 C, or at least 60 C, or at least 70 C, or at least 80 C, or at least 100 C higher than the softening point of the binder. If the temperature is low enough to prevent polymer flow, the thermoplastic polymer does not have sufficient chain mobility to anchor into the surface of the active media and efficiently act as a binder to produce a monolith with mechanical integrity. Mechanical integrity can be defined as a simple Pass/Fail, where mechanical integrity fails if there is greater than 20 wt % of the block composition that is not attached to the block structure right after the block is formed. If the temperature is high enough to allow for efficient binding, then polymer flow occurs and the binder can spread on the surface of the active media and block the entry to some of the pores.

Because process equipment to make the monoliths does not typically apply pressure and temperature homogeneously on the composition, the use of thermoplastic polymer binders typically leads to a gradient of binding efficiency and fouling inside the monolith, while providing good structural integrity and mechanical strength. This is especially true for larger monoliths, where fouling tends to be significant close to the external surface of the monolith in contact with the equipment metal, and where binding tends to be poor in the core of the monoliths away from the metal.

Therefore, there is a need to improve upon the currently described thermoplastic polymer binders, in order to further reduce the fouling of the active media, and improve the overall performance of the monolith. There is also a need to widen the processing window in order to make monolith of any size with efficient binding and extremely low fouling of the active media throughout the monolith.

We have now found that crosslinked thermoplastic polymers, those which were crosslinked prior to being used for this invention, can be used to bind active media in such a manner as to create interconnectivity of the media particles with minimal fouling of the surface and pores. Surprisingly, particles of crosslinked thermoplastic polymers were found to combine enough localized chain mobility on the outside of the particles to effectively bind particles of active media, while undergoing little to no deformation (polymer flow) during the process of making a monolith. The resulting monoliths featured good to excellent mechanical strength and extremely low fouling of the active media.

Mechanical strength of the blocks is assessed visually and given a “Pass” or “Fail” result. “Pass” means that the block is structurally stable when set on a flat surface, whereas “Fail” means that the block does not hold together and at least partially crumbles.

Fouling is measured by the loss of BET surface area per gram of active media, when going from the active media alone to the block structure. The percent fouling of the active media is the percent loss of the BET surface area per g of active media when the active media is turned into a block. It is calculated as [1−(BET specific surface area of block*100)/(BET specific area of sorbent*wt. % sorbent in block)]*100. High fouling corresponds to greater than 20% fouling, low fouling correspond to 1 to 10% fouling, extremely low fouling correspond to less than 1% fouling. Percent fouling is defined as the percent loss of BET surface area of 1 g of active media when the active media is turned into a block or monolith. BET surface area is measured using a QUANTACHROME NOVA-E gas sorption instrument. Nitrogen adsorption and desorption isotherms are generated at 77K. The multi-point Brunauer-Emmett-Teller (BET) nitrogen adsorption method is used to determine the specific surface area.

Alternatively, fouling in a block can also be defined as a loss of porosity compared to a theoretical value calculated for zero % fouling, such theoretical value being in the range of 0.3 to 0.9, or 0.4 to 0.8 or 0.5 to 0.7. Porosity can be calculated from the bulk density and the skeletal density of the block, as porosity=1−(bulk density/skeletal density). Bulk density is the mass of the block divided by the volume occupied by the block. Skeletal density is the mass of the block divided by the volume occupied by the solid matter in the block, which can be determined using helium pycnometry per ASTM B923-10. Fouling is considered low if the loss of porosity is less than 20% or less than 10%, fouling is considered extremely low if the loss of porosity is less than 9% or less than 5% or less than 1%.

The processing window can be much wider, as higher temperature and/or longer times can be used in compression molding or extrusion without significantly increasing polymer deformation of the binder, to achieve excellent binding throughout the structure while keeping fouling to an extremely low level. For instance, temperatures higher than 40 C above the softening point of the thermoplastic polymer binder, or 60 C above, or 70 C above, or 80 C above, or 100 C higher the softening point of the thermoplastic polymer binder can be used. This is especially useful to produce larger blocks.

The bound active media can be formed into porous articles for the filtration, separation, or storage of fluid components. The porous articles are especially useful for the removal of contaminants from potable water; the separation of contaminants from liquid or gaseous industrial streams; the capture and recovery of small molecules from fluid streams, such as biological and pharmaceutically active moieties, and precious metals, and the performance of specific chemical reactions, such as through catalysis. Depending on the type of activity of the active media, it may separate the dissolved or suspended materials by chemical reaction, physical entrapment, electrical (charge or ionic) attraction, or similar means. The porous articles are also useful for the safe storage or transport of gases at moderate pressures, due to the ability of the active media to adsorb gas molecules.

This invention solves a problem common to monoliths made of active media and thermoplastic polymer binders, which is the partial loss of performance of the active media due to fouling of its surface by the binder. The fouling occurs because the binder partially fouls or coats the surface and/or blocks the entrance to pores of the active media. This can happen in two ways. The first way is when a binder is used as a solution, in which case the binder coats the surface of the active media in the form of a thin film. The second way is when a binder is used as a solid, dry or suspended in a liquid, in which case fouling occurs from deformation of the binder (polymer flow) under the pressure and temperature conditions used to make the monolith.

### SUMMARY OF THE INVENTION

The invention relates to a solid porous article having a crosslinked thermoplastic binder interconnecting one or more types of interactive powdery materials or fibers. The interconnectivity is such that the binder connects the powdery materials or fibers in discrete spots rather than as a complete coating, allowing the materials or fibers to be in direct contact with, and interact with a fluid. The resulting article is a formed multicomponent, interconnected web, with porosity. The article is useful in water purification, separation of dissolved or suspended materials in both aqueous and non-aqueous systems in industrial uses, gas storage, electrodes for energy storage devices.

The invention provides for a composition having of interactive particles and from 0.5-30%, preferably from 1 to 20 weight percent of one or more types of crosslinked thermoplastic polymer binder particles based on total weight of interactive particles and crosslinked polymer. The invention also provides for a solid porous article having at least 70% by weight of interactive particles and 0.5-30% by weight of crosslinked thermoplastic polymer binder particles based on total weight of the article. The invention also provides for a process to form the solid porous article. The invention also provides for a method for separating fluids and a method of gas storage using the solid porous article.

The interactive particles exhibit interconnectivity once formed into the porous article. The interconnectivity is such that the binder connects the powdery materials or fibers in discrete points as discrete particles rather than as a complete coating, allowing the materials or fibers to be in direct contact with, and interact with a fluid. The resulting article is a formed multicomponent, interconnected web, with porosity. The article is useful in water purification, as well as in the separation of dissolved or suspended materials in both aqueous, non-aqueous and gaseous systems in industrial uses. The separation article can function at ambient temperature, as well as at elevated temperatures. The article can be used in a gas storage application. The article can be used in an energy storage application.

### DETAILED DESCRIPTION OF THE INVENTION

As used herein, copolymer refers to any polymer having two or more different monomer units, and would include terpolymers and those having more than three different monomer units.

The references cited in this application are incorporated herein by reference.

“Interconnectivity”, as used herein, means the active particles or fibers are permanently bonded together by the fluoropolymer or polyamide binder without completely coating the interactive particles or fibers. The binder adheres the interactive particles together at specific discrete points to produce an organized, porous structure. The porous structure allows a fluid to pass through the interconnected particles or fibers, and the fluid composition is exposed directly to the surface(s) of the interactive particles or fibers, favoring the interaction of the particles with components of the fluid composition, resulting in separation of the components. Since the polymer binder adheres to the interactive particles in only discrete points, less binder is used for full connectivity then in a coating.

Percentages, as used herein are weight percentages, unless noted otherwise, and molecular weights are weight average molecular weights, unless otherwise stated.

One or more crosslinked thermoplastic polymer binders are combined with one or more active media, such as activated carbon, to form a solid structure.

The crosslinked thermoplastic polymer binders of the invention result in virtually no fouling of the active media, leading to a higher retention of its specific surface area and pore volume, and as a result to a higher performance of the block structure for the targeted uses.

The crosslinked thermoplastics of the invention can allow a wider processing window to make block structures by compression molding or extrusion, and the ability to produce homogeneous block structures of all sizes.

### THERMOPLASTIC POLYMERS

The crosslinked thermoplastics of this invention do not include thermoset polymers. Some examples of thermoset polymers are epoxy resins, vulcanized rubber, melamine resins, standard polyurethane resins.

Thermoplastic polymers that can be crosslinked for use in this invention include fluoropolymers, polyamides, acrylic polymers, styrene-butadiene rubbers (SBR), ethylene vinyl acetate (EVA), polyimides, polyurethanes, styrenic polymers, polyolefins including polyethylene and polypropylene, thermoplastic polyesters including polyethylene terephthalate, polybutylene terephtalate, and polylactic acid, cellulosics, polyvinyl chlorides, polycarbonate and thermoplastic polyurethane (TPU).

Preferred thermoplastic polymers that can be crosslinked for use in this invention include fluoropolymers, polyamides, acrylic polymers, styrenic polymers, polyolefins, polyesters.

### Fluoropolymers

The term fluoropolymer denotes any polymer that has in its chain at least one monomer chosen from compounds containing a vinyl group capable of opening in order to be polymerized and that contains, directly attached to this vinyl group, at least one fluorine atom, at least one fluoroalkyl group or at least one fluoroalkoxy group. Examples of fluoromonomers include, but are not limited to vinyl fluoride; vinylidene fluoride (VDF); trifluoroethylene (VF3); chlorotrifluoroethylene (CTFE); 1,2-difluoroethylene; tetrafluoroethylene (TFE); hexafluoropropylene (HFP); perfluoro(alkyl vinyl) ethers, such as perfluoro(methyl vinyl) ether (PMVE), perfluoro(ethyl vinyl) ether (PEVE) and perfluoro(propyl vinyl) ether (PPVE); perfluoro(1,3-dioxole); perfluoro(2,2-dimethyl-1,3-dioxole) (PDD).

Preferred fluoropolymers, include homopolymers and copolymers having greater than 50 weight percent of fluoromonomer units by weight, preferably more than 65 weight percent, more preferably greater than 75 weight percent and most preferably greater than 90 weight percent of one or more fluoromonomers. Other monomers units in these polymers include any monomer that contains a polymerizable C═C double bond.

Most preferred copolymers and terpolymers of the invention are those in which vinylidene fluoride units comprise greater than 50 percent of the total weight of all the monomer units in the polymer, and more preferably, comprise greater than 70 percent of the total weight of the units. Copolymers, terpolymers and higher polymers of vinylidene fluoride may be made by reacting vinylidene fluoride with one or more monomers from the group consisting of vinyl fluoride, trifluoroethene, tetrafluoroethene, one or more of partly or fully fluorinated alpha-olefins such as 3,3,3-trifluoro-l-propene, 1,2,3,3,3-pentafluoropropene, 3,3,3,4,4-pentafluoro-1-butene, and hexafluoropropene, the partly fluorinated olefin hexafluoroisobutylene, perfluorinated vinyl ethers, such as perfluoromethyl vinyl ether, perfluoroethyl vinyl ether, perfluoro-n-propyl vinyl ether, and perfluoro-2-propoxypropyl vinyl ether, fluorinated dioxoles, such as perfluoro(1,3-dioxole) and perfluoro(2,2-dimethyl-1,3-dioxole), allylic, partly fluorinated allylic, or fluorinated allylic monomers, such as 2-hydroxyethyl allyl ether or 3-allyloxypropanediol, and ethene or propene.

Fluoropolymers such as polyvinylidene-based polymers are made by any process known in the art. Processes such as emulsion and suspension polymerization are preferred and are described in U.S. Pat. No. 6,187,885, and EP0120524.

### Synthetic Polyamides

A polyamide is a polymer (substance composed of long, multiple-unit molecules) in which the repeating units in the molecular chain are linked together by amide groups. Amide groups have the general chemical formula CO-NH. They may be produced by the interaction of an amine (NH₂) group and a carboxyl (CO₂H) group, or they may be formed by the polymerization of amino acids or amino-acid derivatives (whose molecules contain both amino and carboxyl groups).

The synthesis of polyamides is well described in the art, examples are WO15/071604, WO14179034, EP0550308, EP0550315, U.S. Pat. No. 9637595.

Polyamides can be condensation or ring opening products:
of one or more amino acids, such as aminocaproic, 7-aminoheptanoic, 11-aminoundecanoic and 12-aminododecanoic acid, or of one or more lactams such as caprolactam, oenantholactam and lauryllactam; with
of one or more salts or mixtures of diamines such as hexamethylenediamine, dodecamethylenediamine, meta-xylylenediamine, bis(p-aminocyclohexyl)methane and trimethylhexamethylenediamine with diacids such as isophthalic, terephthalic, adipic, azelaic, suberic, sebacic and dodecanedicarboxylic acid.

Examples of polyamides can include PA 6, PA 7, PA 8, PA9, PA 10, PAll, and PA 12 and copolyamides like PA 6,6.

The copolyamides can be from the condensation of at least two alpha, omega-amino carboxylic acids or of two lactams or of one lactam and one alpha,omega-amino carboxylic acid. The copolyamides can be from the condensation of at least one alpha,omega-amino carboxylic acid (or one lactam), at least one diamine and at least one dicarboxylic acid.

Examples of lactams include those having 3 to 12 carbon atoms on the main ring, which lactams may be substituted. For example, of β,β-dimethylpropiolactam, α,α-dimethyl-propiolactam, amylolactam, caprolactam, capryllactam and lauryllactam.

Examples of alpha,omega-amino carboxylic acids include aminoundecanoic acid and aminododecanoic acid. Examples of dicarboxylic acids include adipic acid, sebacic acid, isophthalic acid, butanedioic acid, 1,4-cyclohexanedicarboxylic acid, terephthalic acid, the sodium or lithium salt of sulphoisophthalic acid, dimerized fatty acids (these dimerized fatty acids having a dimer content of at least 98% and preferably being hydrogenated) and dodecanedioic acid, HOOC—(CH₂)₁₀—COOH.

The diamine can be an aliphatic diamine having 6 to 12 carbon atoms; it may be of aryl and/or saturated cyclic type. Examples include hexamethylenediamine, piperazine, tetramethylene diamine, octamethylene diamine, decamethylene diamine, dodecamethylene diamine, 1,5-diamino hexane, 2,2,4-trimethyl-1,6-diaminohexane, diamine polyols, isophorone diamine (IPD), methylpentamethylene diamine (MPDM), bis(aminocyclohexyl)methane (BACM) and bis(3-methyl-4-aminocyclohexyl)methane (BMACM).

Examples of copolyamides include copolymers of caprolactam and lauryllactam (PA 6/12), copolymers of caprolactam, adipic acid and hexamethylenediamine (PA 6/6-6), copolymers of caprolactam, lauryllactam, adipic acid and hexamethylene diamine (PA 6/12/6-6), copolymers of caprolactam, lauryllactam, 11-aminoundecanoic acid, azelaic acid and hexamethylenediamine (PA 6/6-9/11/12), copolymers of caprolactam, lauryllactam, 11-amino undecanoic acid, adipic acid and hexamethylene diamine (PA 6/6-6/11/12), and copolymers of lauryllactam, azelaic acid and hexamethylenediamine (PA 6-9/12).

Polyamides also include polyamide block copolymers, such as polyether-b-polyamide and polyester-b-polyamide.

Another polyamide is Arkema's ORGASOL® ultra-fine polyamide 6, 12, and 6/12 powders, which are microporous, and have open cells due to their manufacturing process. These powders have a very narrow particle size range that can be between 5 and 60 microns, depending on the grade. Lower average particle sizes of 5 to 20 are preferred.

Acrylic polymers as used herein is meant to include polymers, copolymers and terpolymers formed from methacrylate and acrylate monomers, and mixtures thereof. The methacrylate monomer and acrylate monomers may make up from 51 to 100 percent of the monomer mixture, and there may be 0 to 49 percent of other ethylenically unsaturated monomers, included but not limited to, styrene, alpha methyl styrene, acrylonitrile. Suitable acrylate and methacrylate monomers and comonomers include, but are not limited to, methyl acrylate, ethyl acrylate and ethyl methacrylate, butyl acrylate and butyl methacrylate, iso-octyl methacrylate and acrylate, lauryl acrylate and lauryl methacrylate, stearyl acrylate and stearyl methacrylate, isobornyl acrylate and methacrylate, methoxy ethyl acrylate and methacrylate, 2-ethoxy ethyl acrylate and methacrylate, dimethylamino ethyl acrylate and methacrylate monomers. (Meth) acrylic acids such as methacrylic acid and acrylic acid can be comonomers. Acrylic polymers include multilayer acrylic polymers such as core-shell structures typically made by emulsion polymerization.

Styrenic polymers as used herein is meant to include polymers, copolymers and terpolymers formed from styrene and alpha methyl styrene monomers, and mixtures thereof. The styrene and alpha methyl styrene monomers may make up from 50 to 100 percent of the monomer mixture, and there may be 0 to 50 percent of other ethylenically unsaturated monomers, including but not limited to acrylates, methacrylates, acrylonitrile. Styrene polymers include, but are not limited to, polystyrene, acrylonitrile-styrene-acrylate (ASA) copolymers, styrene acrylonitrile (SAN) copolymers, styrene-butadiene copolymers such as styrene butadiene rubber (SBR), methyl methacrylate-butadiene-styrene (MBS), and styrene-(meth)acrylate copolymers such as styrene-methyl methacrylate copolymers (S/MMA).

Polyolefin as used herein is meant to include polyethyene, polypropylene, and copolymers of ethylene and propylene. The ethylene and propylene monomers may make up from 51 to 100 percent of the monomer mixture, and there may be 0 to 49 percent of other ethylenically unsaturated monomers, including but not limited to acrylates, methacrylates, acrylonitrile, anhydrides. Examples of polyolefin include ethylene ethylacetate copolymers (EVA), ethylene (meth)acrylate copolymers, ethylene anhydride copolymers and grafted polymers, propylene (meth)acrylate copolymers, propylene anhydride copolymers and grafted polymers.

### CROSSLINKED THERMOPLASTIC POLYMERS

The crosslinked thermoplastic polymers used in this invention have chemical bonds between adjacent polymer chains, resulting from the use of crosslinking agents and/or radiation source. Crosslinked thermoplastic polymers used in this invention can be blended (crossed linked either before or after blending) or sequentially polymerized into interpenetrating networks or core-shell structures. An example of sequentially polymerizing is acrylic modified fluoropolymers can be made of an emulsion fluoropolymer seed and subsequent acrylic polymerizations.

Crosslinked thermoplastic polymers are insoluble in strong organic solvents known in the art to be a suitable solvent for the corresponding non-crosslinked thermoplastic polymer, such as methyl isobutyl ketone, or methyl ethyl ketone, or N-Methyl-2-pyrrolidone. Per ASTM D543, when crosslinked thermoplastic polymers are exposed to such chemicals by immersion for 2 hours or 10 hours or 24 hours at room temperature, the polymers don't dissolve in the solvent, but instead swell and form a gel-like material that cannot be filtered through a PTFE filter of 0.5 microns. Polymers are considered crosslinked polymers if less than 20 wt % or less than 10 wt % or less than 5 wt % of the polymer is present in the filtrated solution. Crosslinked thermoplastic polymers have a viscosity greater than 20 Kpoise, preferably greater than 40 Kpoise, more preferably greater than 50 Kpoise, according to ASTM D-3835 at a temperature of 230 C and a frequency of 100 sec−1. Crosslinked thermoplastic polymers also have a complex viscosity of more than 10,000,000 sec⁻¹, at temperature of 230 C, when measured by ASTM D4440-01 or ISO 6721 part 10, at a frequency of 0.1 Hz. This is a dynamic mechanical analysis where the sample is placed into a Parallel-Plate Oscillatory Rheometer, the temperature is raised to 250 C from room temperature at a rate of 5 C per minute, then the complex viscosity is measured as a function of the temperature, as the temperature is being ramped back down to room temperature at a rate of 2 C, or 5 C or 10 C or 20 C per min.

Crosslinked thermoplastic polymers can be prepared by any process known in the art such as emulsion polymerization, suspension polymerization, solvent polymerization, mass polymerization, and possibly including post-polymerization processes such as reactive extrusion and radiation curing. Examples of radiation are ultraviolet (UV), gamma, e-beam.

Crosslinked thermoplastic polymers useful for this invention are in the form of a particulate material, either in dry form or suspended in aqueous media. Particles of crosslinked thermoplastic polymers can be of any size and size distribution. When in the form of powder, the average particle size of the particles is from 1 to 500 microns or 2 to 200 microns or 5 to 100 microns or 10 to 50 microns or 10 to 20 microns. In one embodiment the particles are made of agglomerates of discrete particles, where the average particle size of the discrete particles is less than 10 microns, preferably less than 5 microns, more preferably less than 1 micron, more preferably less than 500 nm, and even less than 300 nm. For example, polymers made by emulsion polymerization, such as polyvinylidene fluoride, acrylic polymers, styrenic polymers, styrene butadiene rubber, polyamides, can have discrete particle size. Polymers made by other processes, such as polyolefin, polyamide, polyvinylidene fluoride, acrylic polymers, styrenic polymers, are made of powder particles, where the particles are not made of agglomerates of discrete particles.

Particles of crosslinked thermoplastic polymers can be of any shape including round, close to round, fibrils, or various ill-defined shapes. Crosslinked thermoplastic polymers can be advantageously prepared by polymerization in a dispersed medium, such as suspension polymerization or emulsion polymerization. These processes typically produce fairly round particles suspended in aqueous media. Upon drying, suspension polymer powders contain particles that remain fairly round, whereas emulsion polymers tend to produce powders with various ill-defined shapes that are made of agglomerates of discrete round particles. Dry particles can be obtained by any process known in the art such as spray drying, coagulation drying, tray drying, extrusion, grinding, and milling.

Particles of crosslinked thermoplastic polymers can be made of a single thermoplastic polymer, a blend of 2 or more thermoplastic polymers, or layers of thermoplastic polymers where at least one layer is crosslinked.

U.S. Pat. No. 7,868,062 describes the preparation of highly crosslinked particles of acrylic thermoplastic polymers by suspension polymerization. The resulting crosslinked particulate material cannot be dissolved in strong organic solvents such as tetrahydrofuran and methylene chloride. Particles made of layers of thermoplastics can be multi-stage, sequentially-produced polymer having a core-shell particle structure. The core-shell particle may have two or more layers, with at least one layer being crosslinked with the use of a crosslinking agent during the polymerization of the polymer layer. In one embodiment, all layers of the particles are crosslinked, in another embodiment the particle contains at least one crosslinked inner layer and at least one non crosslinked layer. The multi-stage polymer can be produced by any known technique for preparing multiple-stage, sequentially-produced polymers, for example, by emulsion polymerizing a subsequent stage mixture of monomers in the presence of a previously formed polymeric product. In this type of polymerization, the succeeding stage is attached to and intimately associated with the preceding stage. Examples of acrylic core-shell particles are described and referenced in US patents: U.S. Pat. Nos. 3,661,994, 4,521,568, US2003/0216510, and US2013317175. Examples of fluorinated core-shell particles are described in JP2018-172595A.

Crosslinked thermoplastic polymers can be obtained by chemical, thermal, or radiation crosslinking processes. Chemical crosslinking agents can be used during the polymerization of thermoplastic monomers. For thermoplastic polymers that are produced by radical or ionic processes, such as fluoropolymers, acrylic polymers, styrenic polymer, typical crosslinking agents are polyfunctional monomers containing 2 or more C═C double bonds, including aliphatic and aromatic vinyl, allyl, methallyl, crotyl, monomers. . Examples of such crosslinking (sometimes referred to as graftlinking) monomers are described in US2013317175, and include but are not limited to divinyl benzene, trivinylbenzene, butadiene, isoprene, diallylphtalate, diallyl methacrylate, butanediol di(meth)acrylate, ethyleneglycol di(meth)acrylate, diethyleneglycol di(meth)acrylate. Trymehylolpropane tri(meth)acrylate, divinylsulfone, 1,3-butylene dimethacrylate, and combinations thereof. Preferred crosslinking monomers are polyvinyl benzene, polyallyl(methl)acrylates, poly(meth)acrylates, and polyallylphtalates, where “poly” can mean di, tri, tetra, and greater than tetra. The crosslinking monomers are incorporated in the mixture of monomers from 0.1 to 55 weight percent, preferably 0.2 to 20 weight percent, most preferably 0.5 to 10 weight percent. For thermoplastic polymers that are produced by polycondensation processes, such as polyamides, typical crosslinking agents include polyfunctional acids or polyfunctional amines with a functionality or more than 2, as described in U.S. Pat. No. 8,546,614.

Chemical and/or radiation crosslinking of thermoplastic polymers can also be completed in post-polymerization processes, such as solution crosslinking, reactive extrusion, reactive injection molding, and/or radiation curing. An example of reactive extrusion process to crosslink polyamide is described in EP2219698. In a first reactive extrusion step, the polyamide is modified a) with either a bifunctional or monofunctional crosslink-reactive compound comprising at least one reactive site allowing crosslinking or reaction with crosslinkers, or b) with triallyl isocyanurate (TAIL) or derivative thereof. In a second step, the modified polyamide is undergoing a crosslinking reaction by treatment with at least one form of energy.

U.S. Pat. 8,480,917 described the preparation of crosslinked PVDF by heating a solution of PVDF-based polymer and crosslinking agents. Examples of crosslinking agent may include dicumyl peroxide, benzolyl peroxide, bisphenol A, methylenediamine, ethylenediamine, isopropylethylenediamine, 1,3-phenylenediamine, 1,5-naphtalenediamine, 2,4,4-trimethyl-1,6-hexanediamine. The crosslinking agent is used at 0.1 to 10 wt % based on the weight of the polymer. Whether the PVDF-based polymer has been crosslinked can be determined by dynamic mechanical analysis (DMA), differential scanning calorimetry, or a solubility test. When the PVDF-based polymer is crosslinked, chains of the polymer molecules are linked together and thus are not dissolved in strong organic solvents like those used to perform the crosslinking reaction, such as methyl isobutyl ketone, or methyl ethyl ketone. A similar process for crosslinking fluoropolymers in the presence of an organic base is described in WO19027899. Examples of organic bases include 1,8-diazabicyclo-undec-7ene, 1.5-diazabibyclo-non-5-ene, tetramethylguanidine, trimethylamine, hexamethylenediamine, methylamine, dimethylamine, ethylamine, azetidine, isopropylamine, propylamine, 1,3-propanediamine, pyrrolidine, N,N-dimethylglycine, butylamine, tert-butylamine, piperidine, choline, hydroquinone, cyclohexylamine, diisopropylamine, 4-dimethylaminopyridine, diethylenetriamine, 4-aminophenol. In one example, 1,8-diazabicyclo-undec-7ene was used at 2 wt % percent based on the polymer weight.

U.S. Pat. No. 3,923,947 described a process to crosslink polyethylene by reactive extrusion in the presence of a peroxy compound, used at 0.1 to 5 wt % loading. Suitable peroxy compounds include 2,5-dimethyl-2,5-di(tertiarybutylperoxy)hexyne-3, 2,5-dimethyl-2,6-di(tertiarybutylperoxy)hexane, 1,3,5-tri-2-(tertbutylperoxy)diisopropyl benzene, and 1,3,5-tri(tertbutylperoxy)isopropyl benzene.

Mixtures of one or more types of crosslinked thermoplastic polymers is also anticipated, for use as the binder of the invention. In all cases, crosslinking occurs before combining the thermoplastic polymer with interactive particles or fibers to make a block or monolith.

### INTERACTIVE PARTICLES OR FIBERS

One or more types of interactive particles, which can also be in the shape of fibers, are combined with the crosslinked thermoplastic polymer binder of the invention. The interactive particles or fibers of the invention are those which have a physical, electrical, or chemical interaction when they come into proximity or contact with dissolved or suspended materials in a fluid (liquid or gas) composition. Depending on the type of activity of the interactive particles, the particles may separate the dissolved or suspended materials by chemical reaction, physical entrapment, physical attachment, electrical (charge or ionic) attraction, or similar means.

Examples of interactive particles or fibers include, but are not limited to: metallic particles of 410, 304, and 316 stainless steel, copper, aluminum and nickel powders, ferromagnetic materials, activated alumina, activated carbon, carbon nanotubes, silica gel, glass beads, various abrasives, common minerals such as silica or titanium dioxide, wood chips, ion-exchange resins, zeolites, ceramics, ion-exchange modified zeolites, diatomaceous earth, talc, graphite, carbon black, metal oxides, lithium ion-transition metal salts. Examples of useful microbiological inception agents include, but are not limited to metal salts, particularly silver and copper salts, including AgBr, Ag Cl, and silver zeolite. Other useful interactive particles or fibers include iron hydroxyoxide—for the adsorption of arsenic, calcium hydroxyapatite—for the adsorption of fluorine, and phosphates, oxides and sulfates—for the precipitation of metals such as lead, nickel and other toxic metals.

In one embodiment, two types of interactive particles or fibers are combined with the binder of the invention, for example activated carbon and ceramic, activated carbon and titanium dioxide, activated carbon and hydroxpatite, activated carbon and zeolite, activated carbon and ion-exchange resin, zeolite and ion-exchange resin, metal particles and graphite, metal particles and carbon black.

The interactive particles or fibers of the invention have an average particle size range of 0.1 to 3,000 micrometers and can have any aspect ratio. Particles in the shape of spheres have an aspect ratio close to 1. Fibers can essentially have unlimited length to width aspect ratio. Fibers are preferably chopped to no more than 5 mm in length, though long fibers can be used with the binder to produce fiber-reinforced structures for improved mechanical strength. Fiber reinforcement provides improved strength to the porous separation article. Interactive particles or fibers should have sufficient thermal conductivity to allow heating of the powder mixtures. In addition, in an extrusion or compression molding process, the particles and fibers must have softening or melting points sufficiently above that of the crosslinked thermoplastic polymer binder in order to prevent both substances from melting and producing a continuous melted phase rather than the usually desired multi phase system.

The ratio of crosslinked thermoplastic polymer binder to interactive particles or fibers is from 0.5-35 weight percent of dry binder to 65 to 99.5 weight percent interactive particles or fibers, preferably from 0.5-20 weight percent of dry binder to 80 to 99.5 weight percent interactive particles or fibers, more preferably from 1-10 weight percent of dry binder to 90 to 99 weight percent interactive particles or fibers. In one embodiment from 1-15 weight percent of dry binder to 85 to 99 weight percent interactive particles or fibers. If less binder is used, complete interconnectivity may not be achieved, and if more binder is used, there is a too much of a reduction in contact between the interactive particles and the fluid passing through the separation article.

The separation articles of the invention differ from membranes. A membrane works by rejection filtration—having a specified pore size, and preventing the passage of particles larger than the pore size through the membrane. The separation articles of the invention instead rely on adsorption or absorption of by interactive particles to remove materials from a fluid passing through the separation device.

### METHOD OF MAKING THE SOLID POROUS ARTICLE

The process of making the article of the invention includes mixing interactive particles or fibers, crosslinked thermoplastic polymers, and optionally additives, into a homogeneous blend. The blend can be formed into the article by means known in the art for forming solid articles. Useful processes for forming the article of the invention include, but are not limited to extrusion, compression molding, and roll compaction.

### Mixing Process

The mixing of interactive particles with binder particles is described in U.S. Pat. No. 5,019,311, incorporated herein by reference. The process involves combining at least one “binder”, consisting of fine particulate material, in dry form or suspended in aqueous media, mixed with one or more types of interactive particles or fibers. The interactive particles and fibers can consist of nearly any granular, powders, or microfine material or a range of fine or coarse fibers. The particles and fibers should have melting or softening points significantly higher than those of the binder particles. To this mixture can be added a variety of additives and processing aids. “Additives” are defined as materials that produce desirable changes in the properties of the final product, such as plasticizers that produce a more elastic or rubbery consistency, or stiffeners that produce a strong, brittle, and more ceramic-like final product. “Processing aids” are defined as materials that allow the mixture to be processed with greater ease, such as lubricants. An example of lubricant is fumed silica. The binder should constitute about 1 to about 30% by weight of the overall mixture and, preferably, about 4 to about 12%.

The mixing process typically used to mix binder and interactive materials (particles and/or fibers) is designed to produce as uniform a final product as possible. The quality of the mixture produced by the mixing equipment is important in the process. The cold mixing process usually requires substantial levels of shear to produce a stable, intimate mixture that will be converted to a strong composite during final processing. For example, ball milling must often be carried out in a modified ball mill equipped with articles to increase shear. Plow mixers must also be modified with articles that “smear” the materials. Generally powder mixtures (those not containing significant quantities of long fibers) can be effectively mixed using a modified ball mill or plow mixer, while mixtures of fibers and particles can be effectively dispersed in a high-intensity mincing mixer.

In addition, it is suspected that the process requires a special distribution of particles within the mixture. Binder particles must be dispersed individually or as small clusters between and upon the surrounding interactive particles. The binder particles must stick to the interactive particles in an effect that produces a low-dusting, slow moving matrix. To supplement this stickiness, binder or interactive particles sometimes need to be coated with a trace of surfactant or similar material.

Alternatively to a dry mixing process, (IR4215) WO/16130410 describes the mixing of interactive particles with an aqueous dispersion of a thermoplastic polymer binder.

### Formation of Monolith or Block or Solid Porous Article

As described in U.S. Pat. No. 5,019,311, the mixture of all particles and components is processed in accordance with the invention by a procedure which may include any of a number of conventional processes often applied to plastics. These include extruding to produce objects with two dimensional uniform shapes, hot roll compacting to produce thin sheets or thick slabs of material, or compression or injection molding to produce complex bulk shapes.

To accomplish the formation of the immobilization or forced point-bonding of the interactive particles or fibers, the plastics molding, extruding, roll compacting, or other forming equipment is operated in such a manner as to obtain a critical combination of applied pressure, temperature, and shear in a required time sequence.

As described in U.S. Pat. Nos. 5,019,311, 5,331,037, processes used to turn a particulate blend into a block or monolith involve heating the blend to a temperature sufficiently above (typically 20 to 40 C) the softening point or melting point of the polymer binder. In combination with pressure and shear applied during the process, such temperature allows the thermoplastic polymer binder to “smear” into thin films that serve as binding points.

In this invention, the use of crosslinked thermoplastic polymer binders inhibits, or at least minimizes the “smearing” of the binder particles. There is only enough polymer deformation on the outside of the binder particles to effectively create binding points, whereas the bulk of the particles have limited mobility. This creates a significant benefit in minimizing the fouling of the interactive particles or fibers.

The speed of the process to make the block is limited primarily by the speed with which heat can be moved into the mixture of particles. As opposed to standard non crosslinked thermoplastic polymers, crosslinked thermoplastic polymer binders can be processed in a wide range of temperatures, between their softening temperature and 20 C above that, or 40 C above that, or 70 C above that, or 80 C above that, or 100 C above that, and provide consistent binding efficiency and extremely low fouling. In an extrusion process, the composition of the invention can be turned into blocks of a wide range of sizes at an extrusion speed of greater than 5 inches per minute, preferably greater than 8 inches per minute, more preferably greater than 10 inches per minute, most preferably greater than 15 inches per minute. In a compression molding process, the composition of the invention can be turned into blocks of a wide range of sizes in a process cycle time of less than 60 minutes, preferably less than 30 minutes, more preferably less than 20 minutes, most preferably less than 10 minutes or less than 5 minutes. For example, blocks can be of cylindrical shape with an outer diameter in the range of 0.5 inch to 50 inch, preferably 1 to 20 inches, more preferably 2 to 10 inches.

The size and shape of the blocks can vary depending on the target application. Blocks can be of any shape and size. A typical example is a block of cylindrical shape with a diameter greater than 1 inch, preferably greater than 2 inches, more preferably greater than 5 inches, most preferably greater than 10 inches. Another typical example is a block of annular shape, with an outside diameter greater than 1 inch, preferably greater than 2 inches, more preferably greater than 5 inches, most preferably greater than 10 inches, and with an inside diameter greater than 0.1 inch, preferably greater than 0.2 inches, more preferably greater than 0.5 inches, most preferably greater than 1 inches

### USES

The articles of the invention can be used for the filtration, separation, or storage of fluids. They can also be used in parts of energy storage devices, such as electrodes of batteries and capacitors. Filtration articles can purify and remove unwanted materials from the fluid passing through the article, resulting in a more pure fluid to be used in various commercial or consumer applications. The article can also be used to capture and concentrate materials from a fluid stream, these captured materials then removed from the separation article for further use. The devices can be used for potable water purification (hot and cold water), and also for industrial uses. By industrial uses is meant uses at high temperatures (greater than 50° C., greater than 75° C., greater than 100° C. greater than 125° C. and even greater than 150° C., or up to the melting point of the polymer binder; uses with organic solvents, and in pharmaceutical and biological clean and pure uses.

Due to the crosslinked nature of the thermoplastic binder of the invention, it provides clear advantages versus standard thermoplastic polymers, including resistance to strong organic chemicals, excellent mechanical and thermo mechanical properties. For instance, chemical resistance of the blocks to methyl isobutyl ketone, or methyl ethyl ketone, or N-Methyl-2-pyrrolidone can be measured by ASTM D543 where blocks made with a crosslinked thermoplastic polymer are exposed to 0.5 to 3% strain while organic chemical is applied with a pipet on the surface of the block frequently enough for the surface to remain wet for a duration of 2 to 24 hours. The resistance to the organic chemical is deemed good if the blocks retain its mechanical integrity, which is defined as a simple Pass/Fail, where mechanical integrity fails if there is greater than 20 wt % of the block composition that is not attached to the block structure right after the chemical exposure. The thermo mechanical properties are measured by dynamic mechanical analysis per ASTM D4440-01 or ISO 6721 part 10, at a frequency of 0.1 Hz or 1 Hz, where G′ and G″ moduli are obtained as a function of temperature. Excellent thermo mechanical properties are obtained when G′ and G″ present a plateau between 200 and 250 C.

The articles of the invention can be used in a variety of different and demanding environments. High temperatures, highly reactive, caustic or acidic environments, sterile environments, contact with biological agents, are environments where the separation articles of the invention have distinct advantages over other non crosslinked thermoplastic polymer binder systems.

Articles of the invention can be any size or any shape. In one embodiment, the article is a hollow tube formed by a continuous extrusion of any length. Water or other fluid flows under pressure through the outside of the tube, and is filtered from the outside to inside of the tube, and is collected after passing through the filter.

Some articles of the invention include, but are not limited to:
a. Oil filters, in which the composite latex can be coated onto the paper filter medium.
b. Carbon block filtration systems, including for the reduction of heavy metals, reduction of antimicrobials, reduction of ionic contaminants, and reduction of pharmaceuticals
c. Ion exchange membranes or columns.
d. Catalysis media for promoting chemical reactions.
e. Bioseparation and recovery of pharmaceutical and biological active ingredients.
f. Gas separation, both from other gases, of gases dissolved in aqueous and non-aqueous media, and particulates suspended in gas.
g. Chemical scrubbers, particularly for flue gasses in a very acidic environment.
h. Chemical resistant protective clothing and coverings.
i. Hot water process (>80° C.) filtration for antiscale build-up and removal of organic contaminants.
j. Automotive exhaust filtration.
k. Closed loop industrial water systems.
l. Industrial water treatment.
m. Exhaust, vent and chimney capture of greenhouse gases.
n. Treatment of contaminated groundwater.
o. Treatment of brine and saline water to potable water.
p. Use as a particulate filter.
q. Treatment in ozone exposure
r. Gas storage
s. Gas transport
t. The purification and/or filtration of:
   aliphatic solvents,
   strong acids,
   hot (>80° C.) chemical compounds,
   hydrocarbons,
   hydrofluoric acid,
   diesel and biodiesel fuels,
   ketones,
   amines,
   strong bases,
   “fuming” acids,
   strong oxidants,
   aromatics, ethers, ketones, glycols, halogens, esters, aldehydes, and amines,
   compounds of benzene, toluene, butyl ether, acetone, ethylene glycol, ethylene dichloride, ethyl acetate, formaldehyde, butyl amines, etc.
u. Potable water filtration, including filtration of salt water, well water, and surface water.
v. Evaporation control devices.
w. Hydrocarbon energy storage devices
x. The removal of inorganic and ionic species from aqueous, non-aqueous, and gaseous suspensions or solutions, including but not limited to cations of hydrogen, aluminum, calcium, lithium, sodium, and potassium; anions of nitrate, cyanide and chlorine; metals, including but not limited to chromium, zinc, lead, mercury, copper, silver, gold, platinum, iron and other precious or heavy metal and metal ions; salts, including but not limited to sodium chloride, potassium chloride, sodium sulfate; and removal of organic compounds from aqueous solutions and suspensions.

Based on the list of exemplary uses, and the descriptions in this description, one of ordinary skill in the art can imagine a large variety of other uses for the article of the invention. Aspects of the invention

Aspect 1: A composition comprising a) one or more types of interactive particles and b) 0.5-30%, preferably from 1 to 20 weight percent of one or more types of crosslinked thermoplastic polymer binder particles based on total weight of interactive particles and crosslinked thermoplastic polymer binder particles.

Aspect 2: The composition of aspect 1 wherein said interactive particles are selected from metallic particles, activated alumina, activated carbon, carbon nanotubes, silica gel, glass beads, silica, titanium dioxide, wood chips, ion-exchange resins, zeolites including ion-exchange modified zeolites and silver modified zeolites , ceramics, diatomaceous earth, talc, graphite, carbon black, metal oxides, lithium ion-transition metal salts such as silver and copper salts, calcium hydroxyapatite, phosphates, oxides and sulfates.

Aspect 3: The composition of aspect 1 wherein said interactive particles are selected from the group consisting of activated carbon, zeolites, ceramics, hydroxyapatite, titanium dioxide.

Aspect 4:The composition of aspect 1 wherein said interactive particles comprise activated carbon.

Aspect 5: The composition of any of aspects 1 to 4 wherein said crosslinked thermoplastic polymer is selected from the group consisting of fluoropolymers, polyamides, acrylic polymers, polyimides, polyurethanes, styrenic polymers, polyolefins, polyesters, polyvinyl chlorides, polycarbonate and thermoplastic polyurethane.

Aspect 6: The composition of any of aspects 1 to 4 wherein said crosslinked thermoplastic polymer is selected from fluoropolymers, polyamides, acrylic polymers, styrenic polymers, polyolefins, polyesters.

Aspect 7: The composition of any of aspects 1 to 4 wherein said crosslinked thermoplastic polymer binder particles comprise fluoropolymers, wherein said fluoropolymers are selected from the group consisting of vinylidene fluoride homopolymers and copolymers, tetrafluoro ethylene homopolymers and copolymers, or chlorotrifluoroethylene homopolymers and copolymers.

Aspect 8: The composition of any of aspects 1 to 4 wherein said crosslinked thermoplastic polymer binder particles comprise polyamides, wherein said polyamides are selected from the group consisting of polyamide 6, polyamide 6,6, polyamide 6,12, polyamide 11, polyamide 12, a block copolymer of polyether-b-polyamide, or polyester-b-polyamide.

Aspect 9: The composition of any of aspects 1 to 4 wherein said crosslinked thermoplastic polymer binder particles comprise acrylic polymers, wherein said acrylic polymers are selected from the group consisting of homopolymers and copolymers comprising methacrylate or acrylate monomers.

Aspect 10: The composition of any of aspects 1 to 4 wherein said styrenic polymers are selected from the group consisting of homopolymers and copolymers comprising styrene or alpha methyl styrene monomers.

Aspect 11: The composition of any of aspects 1 to 4 wherein said polyolefins are selected from the group consisting of homopolymers and copolymers comprising ethylene or propylene monomers.

Aspect 12: The composition of any of aspects 1 to 4 wherein said polyesters are selected from the group consisting of polyethylene terephthalate, polybutylene terephtalate, and polylactic acid.

Aspect 13: The composition of any of aspects 1 to 4 wherein said crosslinked thermoplastic polymer particles have a core-shell structure.

Aspect 14: The composition of any of aspects 1 to 13 wherein said crosslinked thermoplastic polymer has melt viscosity greater than 20 Kpoise, preferably greater than 40 Kpoise, more preferably greater than 50 Kpoise, according to ASTM D-3835 at 230° C. and 100 sec-1.

Aspect 15: The composition of any of aspects 1 to 14 wherein said crosslinked thermoplastic polymer has a complex viscosity of greater than 10⁸ sec⁻¹ when measured by ASTM D4440-01 at a temperature of 230° C. and a frequency of 0.1 Hz.

Aspect 16: The composition of any of aspects 1 to 15 wherein said crosslinked thermoplastic polymer particles have a solubility in methyl ethyl ketone of less than 20%, preferably less than 10%, most preferably less than 5%, after a 24 immersion per ASTM D543.

Aspect 17: The composition of any of aspects 1 to 16 wherein said crosslinked thermoplastic polymer particles have a solubility in tetrahydrofurane of less than 10% after a 24 hour immersion per ASTM D543.

Aspect 18: The composition of any of aspects 1 to 17 wherein said crosslinked thermoplastic polymer particles have a solubility in N-Methyl-2-pyrrolidone of less than 10% after a 24 hour immersion per ASTM D543.

Aspect 19: The composition of any of aspects 1 to 18 wherein said crosslinked thermoplastic polymer particles are in the form of a powder with an average particle size of 1 micron to 250 microns, preferably 5 to 30 microns.

Aspect 20: The composition of any of aspects 1 to 19 wherein said crosslinked thermoplastic polymer particles is in the form of a powder made of agglomerate of discrete thermoplastic polymer particles, where the average particle size of the discrete particles is 20 nanometers to 10 microns, preferably 50 nanometers to 1 micron, most preferably 80 nanometers to 500 nanometers.

Aspect 21: The composition of any of aspects 1 to 19 wherein said crosslinked thermoplastic polymer particles have an average particle size of 20 nanometers to 250 microns, preferably 100 nanometers to 150 micron, more preferably 200 nm to 30 microns, most preferably 200 nanometers to 20 microns.

Aspect 22: The composition of any of aspects 1 to 19 wherein said composition comprises at least 75% by weight of interactive particles and 1-25% by weight of crosslinked thermoplastic polymer particles, preferably at least 80% of interactive particles and 2-20% of crosslinked thermoplastic polymer particles, most preferably at least 85 of interactive particles and 1-15% of crosslinked thermoplastic polymer particles.

Aspect 23: The composition of any of aspects 1 to 22 wherein the composition further comprises additives selected from the group consisting of plasticizers and lubricants.

Aspect 24: A solid porous article comprising a) at least 70% by weight of interactive particles and b) 0.5-30% by weight of crosslinked thermoplastic polymer binder particles based on total weight of the article.

Aspect 25: The solid porous article of aspect 24 wherein said interactive particles are selected from metallic particles, activated alumina, activated carbon, carbon nanotubes, silica gel, glass beads, silica, titanium dioxide, wood chips, ion-exchange resins, zeolites including ion-exchange modified zeolites and silver modified zeolites, ceramics, diatomaceous earth, talc, graphite, carbon black, metal oxides, lithium ion-transition metal salts such as silver and copper salts, calcium hydroxyapatite, phosphates, oxides and sulfates.

Aspect 26: The solid porous article of aspect 24 wherein said interactive particles are selected from the group consisting of activated carbon, zeolites, ceramics, hydroxyapatite, titanium dioxide.

Aspect 27: The solid porous article of aspect 24 wherein said interactive particles comprise activated carbon.

Aspect 28: The solid porous article of any of aspects 24 to 27 wherein said crosslinked thermoplastic polymer is selected from the group consisting of fluoropolymers, polyamides, acrylic polymers, polyimides, polyurethanes, styrenic polymers, polyolefins, polyesters, polyvinyl chlorides, polycarbonate and thermoplastic polyurethane.

Aspect 29: The solid porous article of any of aspects 24 to 27 wherein said crosslinked thermoplastic polymer is selected from fluoropolymers, polyamides, acrylic polymers, styrenic polymers, polyolefins, polyesters and combinations thereof.

Aspect 30: The solid porous article of any of aspects 24 to 27 wherein said crosslinked thermoplastic polymer binder particles comprise fluoropolymers, wherein said fluoropolymers are selected from the group consisting of vinylidene fluoride homopolymers and copolymers, tetrafluoro ethylene homopolymers and copolymers, or chlorotrifluoroethylene homopolymers and copolymers.

Aspect 31: The solid porous article of any of aspects 24 to 27 wherein said crosslinked thermoplastic polymer binder particles comprise polyamides, wherein said polyamides are selected from the group consisting of polyamide 6, polyamide 6,6, polyamide 6,12, polyamide 11, polyamide 12, a block copolymer of polyether-b-polyamide, or polyester-b-polyamide.

Aspect 32: The solid porous article of any of aspects 24 to 27 wherein said crosslinked thermoplastic polymer binder particles comprise acrylic polymers, wherein said acrylic polymers are selected from the group consisting of homopolymers and copolymers comprising methacrylate or acrylate monomers.

Aspect 33: The solid porous article of any of aspects 24 to 27 wherein said styrenic polymers are selected from the group consisting of homopolymers and copolymers comprising styrene or alpha methyl styrene monomers.

Aspect 34: The solid porous article of any of aspects 24 to 27 wherein said polyolefins are selected from the group consisting of homopolymers and copolymers comprising ethylene or propylene monomers.

Aspect 35: The solid porous article of any of aspects 24 to 27 wherein said polyesters are selected from the group consisting of polyethylene terephthalate, polybutylene terephtalate, and polylactic acid.

Aspect 36: The solid porous article of any of aspects 24 to 27 wherein said crosslinked thermoplastic polymer particles have a core-shell structure.

Aspect 37: The solid porous article of any of aspects 24 to 36 wherein said crosslinked thermoplastic polymer has melt viscosity greater than 20 Kpoise, preferably greater than 40 Kpoise, more preferably greater than 50 Kpoise, according to ASTM D-3835 at 230 C and 100 sec⁻¹.

Aspect 38: The solid porous article of any of aspects 24 to 37 wherein said crosslinked thermoplastic polymer has a complex viscosity of greater than 10⁸ s⁻¹ when measured by ASTM D4440-01 at a temperature of 230 C and a frequency of 0.1 Hz.

Aspect 39: The solid porous article of any of aspects 24 to 38 wherein said crosslinked thermoplastic polymer particles have a solubility in methyl ethyl ketone of less than 20%, preferably less than 10%, most preferably less than 5%, after a 24 immersion per ASTM D543.

Aspect 40: The solid porous article of any of aspects 24 to 39 wherein said crosslinked thermoplastic polymer particles have a solubility in tetrahydrofurane of less than 10% after a 24 hour immersion per ASTM D543.

Aspect 41: The solid porous article of any of aspects 24 to 40 wherein said crosslinked thermoplastic polymer particles have a solubility in N-Methyl-2-pyrrolidone of less than 10% after a 24 hour immersion per ASTM D543.

Aspect 42: The solid porous article of any of aspects 24 to 41 wherein said crosslinked thermoplastic polymer particles is in the form of a powder with an average particle size of 1 micron to 250 microns, preferably 5 to 30 microns.

Aspect 43: The solid porous article of any of aspects 24 to 42 wherein said crosslinked thermoplastic polymer particles is in the form of a powder made of agglomerate of discrete thermoplastic polymer particles, where the average particle size of the discrete particles is 20 nanometers to 10 microns, preferably 50 nanometers to 1 micron, most preferably 80 nanometers to 500 nanometers.

Aspect 44: The solid porous article of any of aspects 24 to 42 wherein said crosslinked thermoplastic polymer particles is in the form of a powder with an average particle size of the powder is 1 micron to 250 microns.

Aspect 45: The solid porous article of any of aspects 24 to 44 wherein said composition comprises at least 75% by weight of interactive particles and 1-25% by weight of crosslinked thermoplastic polymer particles, preferably at least 80% of interactive particles and 2-20% of crosslinked thermoplastic polymer particles, most preferably at least 85% of interactive particles and 1-15% of crosslinked thermoplastic polymer particles based on the weight of the article.

Aspect 46: The solid porous article of any of aspects 24 to 45 wherein the composition further comprises additives selected from the group consisting of plasticizers and lubricants.

Aspect 47: A process to form a solid porous article comprising the steps of:
a) providing the composition of any one of aspects 1 to 23,
b) applying heat and pressure to form a solid porous article.

Aspect 48: The process of aspect 47 wherein step b) is accomplished by compression molding or by extrusion.

Aspect 49: The process of aspect 48 wherein the extrusion speed is greater than 5 inches per minute, preferably greater than 8 inches per minute, more preferably greater than 10 inches per minute, most preferably greater than 15 inches per minute.

Aspect 50: The process of aspect 48 wherein the compression molding time is less than 60 minutes, preferably less than 30 minutes, more preferably less than 20 minutes, most preferably less than 10 minutes or less than 5 minutes.

Aspect 51: The process of any of aspects 47 to 50 wherein the solid porous article is a cylindrical shape with an outer diameter in the range of 0.5 inches to 50 inches, preferably 0.1 to 20 inches, more preferably 0.25 to 10 inches, even more preferably 0.5 to 7 inches, or 1 to 20 inches, more preferably 2 to 10 inches.

Aspect 52: The process of any of aspects 47 to 51 wherein step a) includes preparing a crosslinked thermoplastic polymer in the presence of at least one crosslinking agent.

Aspect 53: The process of any of aspects 47 to 52 wherein step a) includes preparing a crosslinked thermoplastic polymer in the presence of a radiation source.

Aspect 54: The process of aspect 52 wherein the crosslinking agent is selected from the group consisting of polyvinyl benzene, polyallyl(methl)acrylates, poly(meth)acrylates, and polyallylphtalates.

Aspect 55: The process of aspect 53 where the radiation source is selected from the group consisting of ultra violet, gamma, e-beam.

Aspect 56: A method for separating components of a fluid comprising the steps of a) providing the solid porous article of any of aspects 24 to 45 wherein and b) passing a fluid through the article, wherein select components of the fluid remain within the article.

Aspect 57: The method of aspect 56 wherein said fluid is selected from the group consisting of gases, water, organic solvents, pharmaceutical preparations and biologic preparation.

Aspect 58: A method of gas storage comprising the steps of a) providing the solid porous article of any of aspects 24 to 45 wherein said porous article is contained with a container having at least one inlet and optionally at least one outlet and b) providing a gas under pressure to the inlet of the container having the solid porous article therein, wherein at least 50% by weight of the total weight of the gas is held within the volume of the porous article, wherein said container is capable of holding a pressurized gas.

Aspect 59: The method of aspect 58 wherein the gas is selected from the group consisting of noble gases, hydrocarbons, hydrogen-based gases, methane, natural gas, CO2, CO, O2, N2, fluorinated gases, halogenated gases, silanes, phosphine, phosgene, boron trihalides, ammonia, hydrogen halide, sulfide, and cyanide, preferably hydrocarbon, methane or natural gas.

Aspect 60: The method of aspect 57 or 58 wherein the container can hold pressurized gas at pressures of from at least 14.7 psi and of up to 30 psi, preferably up to 100 psi, preferably up to 1000 psi and preferably up to 3000 psi and preferably up to 5000 psi.

### EXAMPLES

### Test Methods

Particle size of media such as activated carbon is measured using a TYLER RX-29 sieve shaker. The data is reported either as a weight average particle size, or as a nominal “m×n” size where at least 90 wt % particles are larger than “n’ mesh and at least 90 wt % particles are smaller than “m’ mesh.

Particle size of polymeric powder is measured using a Malvern Masturizer 2000 particle size analyzer. The data is reported as weight-average particle size (diameter)

Powder/latex average discrete particle size is measured using a NICOMP™ 380 submicron particle sizer. The data is reported as weight-average particle size (diameter).

BET specific surface area, pore volume, and pore size distribution of materials are determined using a QUANTACHROME NOVA-E gas sorption instrument. Nitrogen adsorption and desorption isotherms are generated at 77K. The multi-point Brunauer-Emmett-Teller (BET) nitrogen adsorption method is used to characterize the specific surface area. A Nonlocal Density Functional Theory (NLDFT, N2, 77 k, slit pore model) is used to characterize the pore volume and pore size distribution.

Bulk density measurement of materials or blocks are made by measuring the weight of material or block contained in a known volume, after the material or block has been dried at 110 C under vacuum for 8 hours.

Porosity of the materials or blocks is calculated as: Porosity=1−(bulk density/skeletal density). The fraction of fouled pores: The percent fouling of the active media is the percent loss of the BET surface area per g of active media when the active media is turned into a block. It is calculated as [1−(BET specific surface area of block*100)/(BET specific area of sorbent*wt. % sorbent in block)]*100.

Chemical solubility of the polymer binder is determined by ASTM D543 using organic chemicals such as methyl isobutyl ketone, or methyl ethyl ketone, or N-Methyl-2-pyrrolidone. When 1 g of crosslinked thermoplastic polymers is exposed to 50 g of organic chemical by immersion for 2 hours or 10 hours or 24 hours at room temperature, the polymers don't dissolve in the solvent, but instead swell and form a gel-like material that cannot be filtered through a PTFE filter of 0.5 microns. Polymers are considered crosslinked polymers if less than 20 wt % or less than 10 w t% or less than 5 wt % of the polymer is present in the filtrated solution.

The complex viscosity of the polymers is measured by ASTM D4440-01 or ISO 6721 part 10, at a frequency of 0.1 Hz or 1 Hz. This is a dynamic mechanical analysis where the sample is placed into a Parallel-Plate Oscillatory Rheometer, the temperature is raised to 250 C from room temperature at a rate of 5 C per minute, then the complex viscosity is measured as a function of the temperature, as the temperature is being ramped back down to room temperature at a rate of 2 C, or SC Of IOC or 20 C per min..

Mechanical strength of the blocks is assessed visually and given a “Pass” or “Fail” result. “Pass” means that the block is structurally stable when set on a flat surface, whereas “Fail” means that the block does not hold together and at least partially crumbles.

### EXAMPLES

Powder blends are formed by dry blending Jacobi CX coconut shell activated carbon with one or more thermoplastic polymer binders. The activated carbon has a nominal 80 x 325 mesh particle size, a bulk density of about 0.3-0.4 g/cc, a specific surface area BET (m\hat{ }2/g) of 1150, and a porosity of 0.67 to 0.92.

The binder used in example 1 is a cross-linked particle made by suspension polymerization of methyl methacrylate, ethyl acrylate, and allyl methacrylate as the crosslinker. The binder used in example 2 is a three-layer core-shell particle made by sequential emulsion polymerization, the inner layer is made of poly(methyl methacrylate), the intermediate layer is a cross-linked polymer made of butyl acrylate, styrene, and allyl methacrylate, and the outer layer is made of poly(methyl methacrylate). The binder used in comparative example 1b is a non cross-linked particle made by suspension polymerization of methyl methacrylate and ethyl acrylate, in the absence of a crosslinker.

The binders were characterized by dynamic mechanical analysis (DMA) following ASTM D4440. The viscosity of the materials was measured as a function of temperature at a constant frequency of 0.1 Hz. The cross-linked binders of all examples depicted a viscosity higher than 10⁷ sec⁻¹ at a temperature of 230 C, whereas the non-crosslinked binder used in the comparative example depicted a viscosity lower than 10⁷ sec⁻¹ at a temperature of 230 C. The chemical solubility of the binders was tested in methyl isobutyl ketone, or methyl ethyl ketone per ASTM D543. All crosslinked binders used in examples were found to be insoluble in the chemicals after immersion for 24 hours, whereas the non-crosslinked binder used in the comparative example dissolved in both chemicals within 1 hour.

The table below lists the binders used in each example, their loading in weight percent of the total blend, the average particle size of the binder powder, the average discrete particle size of the binder, and the melt viscosity of the binder at 230 C and 0.1 Hz. The blending of the powders is realized in a KitchenAid® Artisan Series 5-Quart Tilt-Head Stand Mixer with a flat beater attachment, at the “Stir” speed for 20 minutes. The powder blend is then compression molded into a self-supporting, porous article, by heating the powder blend at “T(heat)” for 30 minutes, followed by compression molding into a cylinder mold using a cold shop press. Pressure is applied to reach a set height of the porous article, so that the bulk density of the structure is about 0.68 g/cc. The porosity of the article is measured, and a % fouling of the carbon is calculated and reported in the table. Fouling of the carbon is undesirable as it decreases the ability of the carbon to adsorb molecules in a fluid, as intended for the target applications in fluid filtration or fluid storage.

The porosity of the articles made with cross-linked thermoplastic binders is virtually identical to that of the initial carbon powder, which translates into a % fouling close to 0%, or less than 1% or less than 0.4% or less than 0.3% or less than 0.1%. This is because such binders do not have the ability to flow during the compression molding of the article. In contrast, the non cross-linked thermoplastic of comparative example lb leads to article with significantly lower porosity and therefore much higher fouling of the carbon. This is due to the fact that such binder can flow onto the carbon surface, and into some of the carbon pores during the compression molding of the article. In addition, the binder tends to flow onto the surface of the mold and sticks to the metal, rendering it difficult to demold the article without breaking it.

| | | | Complex | Powder | Discrete | | |
|---|---|---|---|---|---|---|---|
| | | Cross- | viscosity in s−1 | particle size | Particle size | Binder | T(heat) |
| Ex | Binder | linked | (230 C., 0.1 Hz) | (micron) | (micron) | Wt % | (F.) |
| 1 | Suspension | Yes | 2.2*10⁸ | 50 | 50 | 12 | 400 |
| | acrylic | | | | | | |
| 2 | Emulsion | Yes | 3.4 *10⁸ | 150 | 0.3 | 12 | 400 |
| | acrylic | | | | | | |
| | core-shell | | | | | | |
| Comp | Suspension | No | 5.2*10⁶ | 50 | 50 | 12 | 400 |
| 1 | acrylic | | | | | | |

| | | | | Block BET | |
|---|---|---|---|---|---|
| | | | Block | surface area | Block % |
| | | | Structural | per g of | fouling |
| | | Cross- | integrity | active media | based |
| Ex | Binder | linked | (visual) | (m2/g) | on BET |
| 1 | Suspension | Yes | Pass | 1,140 | 0.8 |
| | acrylic | | | | |
| 2 | Emulsion | Yes | Pass | 1,148 | 0.17 |
| | acrylic | | | | |
| | core-shell | | | | |
| Comp | Suspension | No | Fail | 846 | 26.4 |
| 1 | acrylic | | | | |

1. A composition comprising a) one or more types of interactive particles and b) 0.5-30 weight percent of one or more types of crosslinked thermoplastic polymer binder particles based on total weight of interactive particles and crosslinked thermoplastic polymer binder particles.

2. The composition of claim 1, wherein said interactive particles are selected from metallic particles, activated alumina, activated carbon, carbon nanotubes, silica gel, glass beads, silica, titanium dioxide, wood chips, ion-exchange resins, zeolites ceramics, diatomaceous earth, talc, graphite, carbon black, lithium ion-transition metal salts, calcium hydroxyapatite, phosphates, oxides and sulfates.

3. The composition of claim 1, wherein said interactive particles are selected from the group consisting of activated carbon, zeolites, ceramics, hydroxyapatite and titanium dioxide.

4. The composition of claim 1 wherein said interactive particles comprise activated carbon.

5. (canceled)

6. The composition of claim 1, wherein said crosslinked thermoplastic polymer is selected from fluoropolymers, polyamides, acrylic polymers, styrenic polymers, polyolefins, polyesters.

7. The composition of claim 1, wherein said crosslinked thermoplastic polymer binder particles comprise fluoropolymers, wherein said fluoropolymers are selected from the group consisting of vinylidene fluoride homopolymers, vinylidene fluoride copolymers, tetrafluoro ethylene homopolymers, tetrafluoro ethylene copolymers, chlorotrifluoroethylene homopolymers and chlorotrifluoroethylene copolymers.

8. (canceled)

9. The composition claim 1, wherein said crosslinked thermoplastic polymer particles have a core-shell structure.

10. (canceled)

11. The composition of claim 1, wherein said crosslinked thermoplastic polymer has a complex viscosity of greater than 10⁸ sec⁻¹ when measured by ASTM D4440-01 at a temperature of 230° C. and a frequency of 0.1 Hz.

12. The composition of claim 1, wherein said crosslinked thermoplastic polymer particles are in the form of a powder with an average particle size of 1 micron to 250 microns.

13. The composition of claim 1, wherein said crosslinked thermoplastic polymer particles have an average particle size of 20 nanometers to 250 microns.

14. (canceled)

15. A solid porous article comprising a) at least 70% by weight of interactive particles and b) 0.5-30% by weight of crosslinked thermoplastic polymer binder particles based on total weight of the article.

16. The solid porous article of claim 15 wherein said interactive particles are selected from metallic particles, activated alumina, activated carbon, carbon nanotubes, silica gel, glass beads, silica, titanium dioxide, wood chips, ion-exchange resins, zeolites. ceramics, diatomaceous earth, talc, graphite, carbon black, lithium ion-transition metal salts, calcium hydroxyapatite, phosphates, oxides and sulfates.

17. The solid porous article of claim 15, wherein said crosslinked thermoplastic polymer is selected from the group consisting of fluoropolymers, polyamides, acrylic polymers, polyimides, polyurethanes, styrenic polymers, polyolefins, polyesters, polyvinyl chlorides, polycarbonate and thermoplastic polyurethane.

18. (canceled)

19. (canceled)

20. The solid porous article of claim 15, wherein said crosslinked thermoplastic polymer has a complex viscosity of greater than 10⁸ s⁻¹ when measured by ASTM D4440-01 at a temperature of 230 C and a frequency of 0.1 Hz.

21. The solid porous article of claim 15, wherein said crosslinked thermoplastic polymer particles is in the form of a powder made of agglomerate of discrete thermoplastic polymer particles, where the average particle size of the discrete particles is 20 nanometers to 10 microns.

22. (canceled)

23. (canceled)

24. (canceled)

25. (canceled)

26. (canceled)

27. (canceled)

28. (canceled)

29. A method for separating components of a fluid comprising the steps of a) providing the solid porous article of claim 15, and b) passing a fluid through the article, wherein select components of the fluid remain within the article.

30. The method of claim 29 wherein said fluid is selected from the group consisting of gases, water, organic solvents, pharmaceutical preparations and biologic preparation.

31. (canceled)

32. (canceled)

33. The solid porous article of claim 15, wherein said interactive particles comprise activated carbon.
